(19) United States
(12) Patent Application Publication
(10) Pub. No.: US 2018/0339480 A1
(43) Pub. Date: Nov. 29, 2018

(54) BAG MAKING MACHINE

(71) Applicants: New IWASHO CO., LTD., Ama-shi (JP); DAC ENGINEERING CO., LTD., Kyoto-shi (JP)

(72) Inventors: Shinji Yanagisawa, Ama-shi (JP); Hiroshi Takamatsu, Ama-shi (JP); Masayuki Yamao, Ama-shi (JP); Minoru Hibino, Ama-shi (JP); Naoki Kaneko, Ama-shi (JP); Yoshitaka Hikami, Ama-shi (JP); Atsuto Tamada, Kyoto-shi (JP); Hiromi Okamoto, Kyoto-shi (JP); Seiji Takagi, Kyoto-shi (JP)

(73) Assignees: New IWASHO CO., LTD., Ama-shi (JP); DAC ENGINEERING CO., LTD., Kyoto-shi (JP)

(21) Appl. No.: 15/976,091

(22) Filed: May 10, 2018

(30) Foreign Application Priority Data
May 29, 2017 (JP) 2017-106009

(51) Int. Cl. B31B 70/00; B31B 70/64; B31B 70/10; B31B 70/16; B31B 70/88

(52) U.S. Cl. CPC B31B 70/006; B31B 70/645; B31B 2155/001; B31B 70/16; B31B 70/88; B31B 70/10

(57) ABSTRACT

A bag making machine for manufacturing bags from an elongated film having print patterns repeatedly printed on one surface or two surfaces at a print pitch corresponding to a predetermined number of bags includes a processing unit configured to process the film for each length corresponding to the predetermined number of bags, a moving mechanism configured to move the processing unit, a shooting device, and an image processing device. The shooting device includes not less than one line sensor installed with a longitudinal direction of the line sensor extending along the widthwise direction of the film and obtains a linear image extending throughout a width of the film for each shooting operation. The image processing device sequentially receives the linear images from the shooting device and detects the actual length of the predetermined number of bags of the film based on an image extending throughout the width of the film.

### BACKGROUND OF THE INVENTION

### 1. Field of the Invention

The present invention relates to a bag making machine.

### 2. Description of Related Art

When a bag making machine makes bags from a film, expansion and contraction sometimes occur in the film due to the tension of the feed rollers, the heat generated in a heat seal process, and subsequent cooling, and the bag pitch sometimes changes. In such a case, when bags are made by sealing and cutting a film at initially set positions, sealing and cutting may not be performed at positions matching print patterns on the film, resulting in defective products. For this reason, conventionally, visual inspections by operators have been made to ascertain whether a sealing position and a cutting position are correct. However, visual inspections by operators lead to low work efficiency.

In order to solve such a problem, the bag making apparatus disclosed in JP No. 2003-33981 A is configured to shoot a print design on a film with a CCD camera and detect image displacements by image processing. Upon continuously detecting the same dimensions different from initially input dimensional values a plurality of times, the apparatus determines that the bag size (i.e., the bag pitch) has slightly changed, and moves the sealing device and the cooling device to positions corresponding to the bag size after the slight change.

The bag making apparatus disclosed in JP No. 2003-33981 A, however, is designed to shoot only a graphic pattern on a specific portion of a film (i.e., part of the graphic pattern) with a CCD camera, as is known from FIG. 1 and the description in paragraph 0018 “The apparatus is configured to detect image displacements, for example, in units of 0.1 mm by image processing of an image obtained by shooting a specific portion (a portion with a clear graphic pattern) selected from the design printed on a packing film with a CCD camera 43 placed at a proper position on the upstream side from the longitudinal sealing device 16 at which continuous feeding is performed.”

Accordingly, the CCD camera needs to be placed at a position where it can shoot a specific portion of the film. Since the position of the CCD camera needs to be changed for each of packing films with different print patterns, it is not easy to make settings before a bag making process.

Although not concerning a bag making machine, the method disclosed in JP No. 2822830 B is available as a defect detection method for sheet-like printed objects using a line sensor. This method is based on the assumption that the print pattern pitch on a sheet to be inspected is constant, but is not designed to inspect a sheet in the process of making bags. Accordingly, the method gives no consideration to the expansion and contraction of sheets due to heat sealing and cooling, and hence cannot detect any change in print pattern pitch.

### SUMMARY OF THE INVENTION

It is an object of the present invention to provide a bag making machine that can restrict the occurrence of defective products because of the ability to know a change in bag pitch and facilitate settings before the start of a bag making process. The object of the present invention can be achieved by a bag making machine having the following arrangement.

There is provided a bag making machine for manufacturing bags or a continuum of bags from an elongated film having print patterns repeatedly printed on one surface or two surfaces at a print pitch corresponding to a predetermined number of bags (e.g., one bag), the machine including a feeding mechanism configured to feed the film in the lengthwise direction of the film, a processing unit (e.g., a transverse sealing device) configured to process (e.g., heat-seal) the film for each length corresponding to the predetermined number of bags, a moving mechanism configured to move the processing unit, a shooting device including not less than one line sensor installed with its longitudinal direction extending along the widthwise direction of the film, placed at a position allowing a surface of the film which has the print patterns to be shot on a feed route for the film fed by the feeding mechanism, and configured to obtain a linear image extending throughout the width of the film for each shooting operation, with a shooting range being a linear range extending throughout the width of the film, and an image processing device configured to sequentially receive the linear images from the shooting device, detect an actual length of the predetermined number of bags of the film and/or a change in the actual length based on an image extending throughout the width of the film, which is formed from the plurality of continuous linear images, and output the actual length and/or the change in the actual length to at least one of the feeding mechanism, the moving mechanism, and a monitor.

According to the present invention, since an actual length corresponding to a predetermined number of bags (i.e., an actual bag pitch) and/or the change in the actual length are output, a change in bag pitch is known. Adjusting the position to perform processing such as sealing, a feed amount, etc., on the basis of the change in bag pitch can restrict the occurrence of defective products. Since an image extending throughout the width of a film is acquired with the line sensor, there is no need to install a camera facing a specific portion of the film. Even when the print pattern on a film changes, shooting can be performed while the line sensor is kept installed at the same position in the bag making machine. This facilitates settings before the start of a bag making process.

In this case, the image processing device can be configured to form a master image having a reference length corresponding to the predetermined number of bags, starting from a predetermined start position, and extending throughout the width of the film from a plurality of continuous linear images or read a master image having the reference length from an external recording medium, and store the master image in a memory, repeatedly perform forming an inspection image having the reference length and extending throughout the width of the film from the plurality of continuous linear images and calculating the matching ratio between the inspection image and the master image stored in memory while shifting the start position of the inspection image in the lengthwise direction of the film, and detect the actual length and/or the change in the actual length on the basis of the start position of the inspection image determined, based on the matching ratio, as an image matching the master image. This arrangement is suitable for setting, in advance, a feed amount corresponding to the reference length of a predetermined number of bags.

The image processing device can be configured to detect a repeated print pattern on the image extending throughout the width of the film and set the repetition pitch as the actual length. This arrangement is suitable when no feed amount is set in advance.

The image processing device may be configured to output the actual length and/or the change in the actual length to the moving mechanism, and the moving mechanism may include a motor configured to move the processing unit, and a motor control unit configured to output, to the motor, a control signal for moving the processing unit so as to perform the processing with respect to the film for each actual length based on the actual length and/or the change in the actual length input from the image processing device. This arrangement can reduce the time of manual adjustment and improve work efficiency.

The image processing device may be configured to output the actual length and/or the change in the actual length to the feeding mechanism, and the feeding mechanism may include a feed roller configured to feed the film, a motor configured to rotate the feed roller, and a feed amount control unit configured to output, to the motor, a control signal for adjusting at least one of the number of revolutions per unit time and a rotation angle of the motor based on the actual length and/or the change in the actual length input from the image processing device. This arrangement can reduce the time of manual adjustment and improve work efficiency.

The image processing device may be configured to calculate the matching ratio between images of corresponding regions obtained when the master image and the inspection image determined as an image matching the master image are equally segmented into a plurality of regions, determine that distortion or uneven thickness of the film has occurred in the region exhibiting the matching ratio lower than a predetermined level, and output a distortion or uneven thickness detection signal to at least one of the feeding mechanism and the monitor. This arrangement can further restrict the occurrence of defective products by adjusting the tension and feed amount of a film in accordance with a detection result.

The image processing device may be configured to output the distortion or uneven thickness detection signal to the feeding mechanism, and the feeding mechanism may include a feed roller configured to feed the film while applying a pressure on the film, and a pressure adjusting unit configured to adjust the pressure that is applied to the film by the feed roller based on the distortion or uneven thickness detection signal input from the image processing device. This arrangement can reduce the time of manual adjustment and improve work efficiency.

The image processing device may be configured to detect displacement in the widthwise direction between the master image and the inspection image determined as an image matching the master image and output, to at least one of the feeding mechanism and the monitor, a detection signal concerning meandering of the film upon continuously detecting displacement exceeding a predetermined range a predetermined plurality of times. This arrangement can further restrict the occurrence of defective products by adjusting the tension and feed amount of a film in accordance with a detection result.

The image processing device may be configured to output the meandering detection signal to the feeding mechanism, and the feeding mechanism may include a dancer roller configured to apply tension to the film, and an air pressure adjusting unit configured to adjust the air pressure applied to the dancer roller based on the meandering detection signal input from the image processing device. This arrangement can reduce the time of manual adjustment and improve work efficiency.

A bag making machine according to another aspect of the present invention is a bag making machine for manufacturing bags or a continuum of bags from an elongated film formed by overlaying a plurality of base material films on each other and having print patterns repeatedly printed on each of two surfaces of the film at a print pitch corresponding to a predetermined number of bags, the machine including a feeding mechanism configured to feed the film in the lengthwise direction of the film, a processing unit configured to process the film for each length corresponding to the predetermined number of bags, a moving mechanism configured to move the processing unit, a first shooting device including not less than one line sensor installed with its longitudinal direction extending along the widthwise direction of the film, placed at a position allowing one surface of the film to be shot on a feed route for the film fed by the feeding mechanism, and configured to obtain a linear image extending throughout the width of one surface of the film for each shooting operation, with a shooting range being a linear range extending throughout the width of the film, a second shooting device including not less than one line sensor installed with its longitudinal direction extending along the widthwise direction of the film, placed at a position allowing the other surface of the film to be shot on the feed route for the film fed by the feeding mechanism, and configured to obtain a linear image extending throughout the width of the other surface of the film for each shooting operation, with a shooting range being a linear range extending throughout the width of the film, and an image processing device configured to sequentially receive the linear images of one surface from the first shooting device, detect the actual length of the predetermined number of bags on one surface based on an image extending throughout the width of one surface, which is formed from the plurality of continuous linear images of one surface, sequentially receive the linear images of the other surface from the second shooting device, detect the actual length of the predetermined number of bags on the other surface based on an image extending throughout the width of the other surface, which is formed from the plurality of continuous linear images of the other surface, detect displacement between the base material films forming two surfaces of the film based on the actual length of the predetermined number of bags on one surface and the actual length of the predetermined number of bags on the other surface, and output a detection signal concerning displacement between the base material films to at least one of the feeding mechanism, the moving mechanism, and a monitor.

Accordingly, it is possible to restrict the occurrence of defective products by adjusting the tension, etc., of a film in accordance with a detection result. Since images of the two surfaces of a film throughout its width are acquired with the line sensors, there is no need to place a camera facing a specific portion of the film. Even when a print pattern on a film changes, it is possible to perform shooting while the line sensors are kept installed at the same position on the bag making machine. This facilitates settings before a bag making process.

### BRIEF DESCRIPTION OF THE DRAWINGS

FIG. 1 is a schematic perspective view showing the overall structure of a bag making machine according to the first embodiment;

FIGS. 2A, 2B, 3A, 3B, 3C and 3D are views for explaining a method for detecting the length of one bag by image processing according to the first embodiment;

FIG. 4 is a flowchart for explaining a method for detecting the length of one bag by image processing according to the first embodiment;

FIGS. 5A and 5B are views for explaining a method for detecting the distortion or uneven thickness of a film by image processing according to the first embodiment;

FIGS. 6A and 6B are views for explaining a method for detecting the meandering of a film by image processing according to the first embodiment;

FIG. 7 is a schematic perspective view showing the overall structure of a bag making machine according to the second embodiment;

FIG. 8 is a block diagram showing the arrangement of a main part according to the second embodiment;

FIG. 9 is a schematic perspective view showing the overall structure of a bag making machine according to the third embodiment;

FIG. 10 is a view for explaining a method for detecting the length of one bag by image processing according to the third embodiment; and

FIG. 11 is a schematic perspective view showing the overall structure of a bag making machine according to the fourth embodiment.

### DESCRIPTION OF THE PREFERRED EMBODIMENTS

### 1. First Embodiment

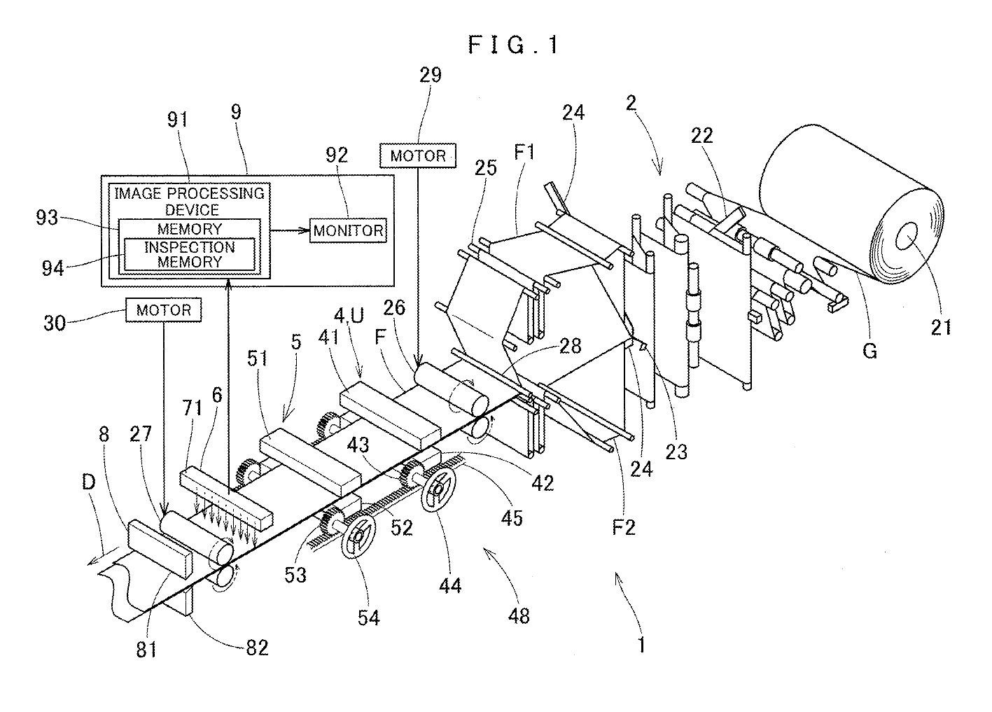

A bag making machine 1 according to the first embodiment shown in FIG. 1 is configured to manufacture bags from an elongated film F having on its one surface print patterns repeatedly printed at a print pitch corresponding to a predetermined number of bags (one bag in this case). The bag making machine 1 performs sealing, cooling, and cutting with respect to a film F for each length corresponding to a predetermined number of bags (one bag in this case). Assume that in the following description, the length of the film F or a bag indicates the length along the lengthwise direction of the film F unless otherwise specified. The bag making machine 1 includes a feeding mechanism 2, a transverse sealing device 4, as a processing unit U, a moving mechanism 48, a cooling device 5, a shooting device 6, a cutter 8, and a computer 9.

The feeding mechanism 2 feeds the film F in its lengthwise direction, and includes a feed shaft 21, a turn bar 22, a slit blade 23, a pair of turn bars 24, 24, a plurality of dancer rollers 25 provided vertically, a pair of adjusting rollers 28, 28, a pair of feed rollers 26, 26, a pair of feed rollers 27, 27, a motor 29, and a motor 30. In this embodiment, both the motors 29 and 30 are servo motors. However, they may not be servo motors. A brake and a motor are coupled to the feed shaft 21. The feed shaft 21 extends through the center of an original roll around which an original film G is wound along the horizontal direction and serves to feed the original film G from the original roll. The turn bar 22 changes the direction of the fed original film G such that its widthwise direction becomes a vertical direction. The slit blade 23 cuts the original film G along the middle in the widthwise direction into base material films F1 and F2. The turn bars 24, 24 change the directions of the base material films F1 and F2 such that the widthwise direction becomes a horizontal direction. The dancer rollers 25 change the continuous feeding to intermittent feeding of the base material films F1 and F2.

The feed rollers 26, 26 are nip rollers. The motor 29 is coupled to one of the rollers 26, 26 to rotate it to overlay the base material films F1 and F2 on each other by applying a pressure. The feed rollers 26, 26 then intermittently feed the overlaid base material films F1 and F2, i.e., the film F, by a predetermined length at one time. The film F is obtained by overlaying the base material films F1 and F2 using the feed rollers 26, 26. Likewise, the motor 30 is coupled to one of the feed rollers 27, 27 to rotate it to intermittently feed the film F a predetermined length at one time.

In addition to the above components, the feeding mechanism 2 includes a plurality of rollers (not shown) for feeding the original film G, the base material films F1 and F2, and the film F.

The length by which a film is intermittently fed at one time (i.e., the length by which a film is fed between the time when the film is stopped first and the time when the film is stopped next) is called a feed amount. The feed amount corresponds to an integer multiple of the length of one bag to be manufactured. In this embodiment, the feed amount is set to the length of one bag. A feed amount can be set by numerical control (i.e., control of the number of revolutions and the rotation angle) on the motor 29 and motor 30.

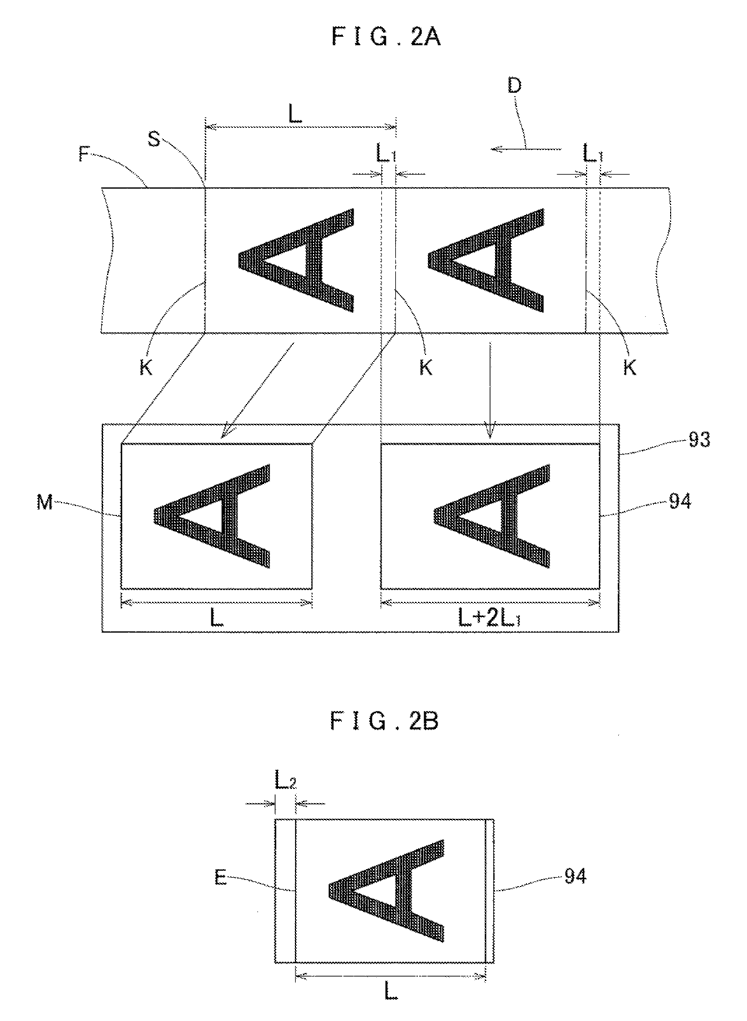

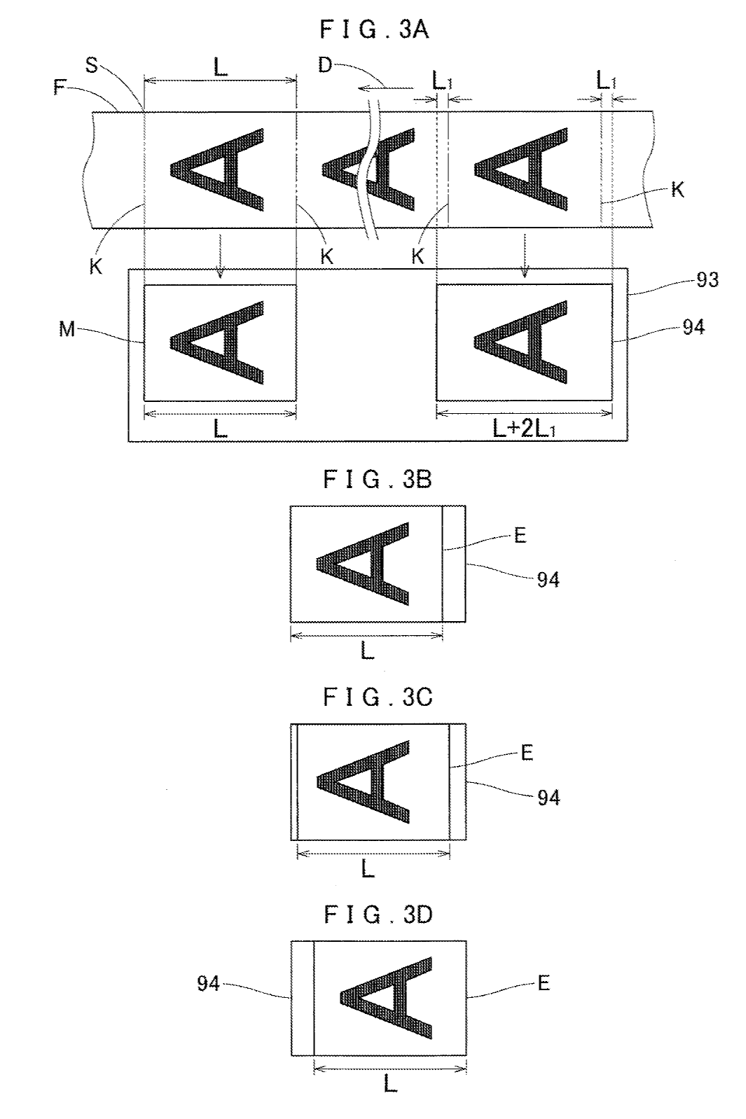

The feeding mechanism 2 feeds the film F while intermittently stopping it. The transverse sealing device 4, the cooling device 5, and the cutter 8 are arranged such that boundary portions K (see FIGS. 2A and 3A) between bags of the film F respectively come to the position to seal, the position to cool, and the position to cut when the film F intermittently stops. In this embodiment, the interval between the position to seal and the position to cool is set to the length of one bag, and the interval between the position to cool and the position to cut is set to the length of two bags. Note that as described above, since expansion and contraction occur in the film F in a bag making process, the transverse sealing device 4, the cooling device 5, and the cutter 8 are arranged on the basis of a bag length planned at first at an early stage of a bag making process.

The base material films F1 and F2, i.e., the film F, each are soft, and are made of a plastic material in this case. However, the material for this film is not specifically limited, and may be a metal material, a paper material, or their composite material. Accordingly, the material for the film F (i.e., the original film G before printing) is not limited to a transparent one. The upper surface of the film F (corresponding to the upper surface of the base material film F1 on the upper side) has a print pattern. A print pattern may be a simple graphic pattern such as a single line or a character or number. Assume that printing has been performed on the entire surface of the film F. In this case, when the printed surface has at least two colors (e.g., a ground color and a color other than the ground color), the surface has a print pattern. Assume that the film F has no optical transparency (e.g., made of a metal material or a plastic material on which a metal film is deposited). In this case, when a color different from a ground color is printed on part of the surface of the film F, the surface has a print pattern. In addition, when the film surface has a colorless portion (i.e., a colorless and transparent portion) and a colored portion, or has a colored and transparent portion and an opaque portion (i.e., a portion having no optical transparency), the surface has a print pattern. Note that “colored” means not being colorless and transparent and includes being colored and transparent. Furthermore, obviously, colors include black and white.

The transverse sealing device 4 is configured to perform a heat seal process for the film F for each length corresponding to one bag, and includes an upper seal bar 41 and a lower seal bar 42. The upper seal bar 41 and the lower seal bar 42 each have an elongated shape and are arranged to face each other with their longitudinal directions extending along the widthwise direction of the film F. The respective seal bars are configured to be heated by heaters. The upper seal bar 41 is attached to a lifting member (not shown) and configured to move up and down (i.e., vertically move) as the lifting member is raised and lowered by a driving mechanism (not shown). When the upper seal bar 41 moves down to the lowest lowered position, the upper seal bar 41 and the lower seal bar 42 hold the film F between them and perform heat sealing (i.e., heat welding) of the base material films F1 and F2 constituting the film F. The bag making machine 1 includes a moving mechanism 48 that moves the transverse sealing device 4. The moving mechanism 48 includes a pinion 43, a handle 44, and a rack 45. The pinion 43 is coupled to the transverse sealing device 4, and the handle 44 is attached to the pivot shaft of the pinion 43. As the handle 44 pivots, the pinion 43 pivots and moves on the rack 45 fixed to the base (not shown) of the bag making machine 1. The transverse sealing device 4 moves, together with the pinion 43, along a feeding direction D of the film F.

The cooling device 5 cools the heat-sealed portion (hereinafter referred to as a “sealed portion”) of the film F to prevent the heat sealed portion from being excessively welded and to provide a good appearance for the heat sealed portion. The cooling device 5 is provided downstream of the transverse sealing device 4 in the feeding direction D of the film F. The cooling device 5 includes an upper cooling bar 51 and a lower cooling bar 52, each having an elongated shape. The upper cooling bar 51 and the lower cooling bar 52 are arranged to face each other, with their longitudinal directions extending along the widthwise direction of the film F. The upper cooling bar 51 has a cooling water path formed inside itself and is attached to a lifting member (not shown). As the lifting member is raised and lowered by a driving mechanism (not shown), the upper cooling bar 51 is raised and lowered. When the upper cooling bar 51 moves down to the lowest lowered position, the upper cooling bar 51 and the lower cooling bar 52 hold the film F between them and cool the film F.

The moving mechanism 48 includes a pinion 53 and a handle 54. The pinion 53 is coupled to the cooling device 5. The handle 54 is attached to the pivot shaft of the pinion 53. As the handle 54 pivots, the pinion 53 moves on the rack 45 while pivoting, and the cooling device 5 moves, together with the pinion 53, along the feeding direction D of the film F. That is, the moving mechanism 48 also serves to move the cooling device 5.

The shooting device 6 is formed from an elongated line sensor 71 and is placed at a position along the feed route for the film F fed by the feeding mechanism 2, at which one surface (the upper surface in this embodiment) of the film F can be shot. The line sensor 71 is installed with its longitudinal direction extending along the widthwise direction of the film F, and is placed downstream of the cooling device 5 in the feeding direction D of the film F. The interval between the position where the cooling device 5 performs cooling and the shooting area of the line sensor 71 is set to the length of one bag. The line sensor 71 is placed on the front surface side (i.e., the upper surface side) of the film F, and shoots the film F from a direction perpendicular to the upper surface of the film F. The line sensor 71 has a plurality of image sensors (e.g., CCD elements), each performing image capturing upon receiving visible light, arranged in a line, and hence has a thin linear shooting area. When the length of the shooting area of the line sensor 71 is shorter than the width of the film F, the shooting device 6 is configured to have a plurality of line sensors 71 linearly arranged side by side so as to perform image capturing of the film F throughout its width. Accordingly, the shooting range (i.e., the shooting area) of the shooting device 6 is set to a linear range extending throughout the width of the film F. The shooting device 6 acquires a linear image extending throughout the width of the film F for each shooting operation. A linear image is an image constituted by linearly arranged pixels. An image extending throughout the width of the upper surface of the film F is formed by shooting the film F with a predetermined period with the shooting device 6 while feeding the film F with the feeding mechanism 2 and arranging linear images sequentially obtained from the shooting device 6. An image extending throughout the width of the film F, which is formed by arranging a plurality of linear images, will also be referred to as a full-surface image of the film F, hereinafter. Note that the length of a full-surface image may be smaller than the total length of the film F.

The line sensor 71 has illumination light sources, each formed from a line of LEDs, on both sides of the line of the image sensors. Accordingly, since the line sensor 71 is configured to irradiate the shooting area with illumination light from a short distance almost equal to a shooting distance, a shooting operation is not easily affected by ambient illumination (i.e., a disturbance factor) such as illumination in a room. Visible light emitted from the illumination light sources of the line sensor 71 is reflected by a colored portion of the film F or a background member corresponding to a colorless portion of the film F and received by the image sensors of the line sensor 71. Note that illumination light sources other than the illumination sources of the line sensor 71 may be provided depending on the type of the film F and the state of a print pattern. In addition, transmission light sources may be provided as illumination light sources instead of the reflectance light sources. The transmission light sources are provided on the opposite side of the line sensor 71 across the film F.

The cutter 8 includes upper and lower elongated cutting blades 81 and 82 facing each other. The upper cutting blade 81 is attached to a lifting member (not shown) and is configured to be raised and lowered as the lifting member is raised and lowered by a driving mechanism (not shown). Note that in the bag making machine 1, the upper seal bar 41 of the transverse sealing device 4, the upper cooling bar 51 of the cooling device 5, and the upper cutting blade 81 of the cutter 8 synchronously move up and down. However, these components may be configured to operate asynchronously when, for example, the intervals between the position to seal, the position to cool, and the position to cut are not integer multiples of the length of one bag.

The computer 9 includes an image processing device 91 that is connected to the shooting device 6 and performs image processing upon receiving linear images output from the shooting device 6 to detect the actual length of one bag of the film F, and a monitor 92 as a display that displays the detection result obtained by the image processing device 91. The image processing device 91 includes a CPU (not shown) and a memory 93. An inspection memory 94 is provided in the memory 93. Image processing performed by the image processing device 91 will be described in detail later.

The operation of the bag making machine 1 will be described next. The bag making machine 1 overlays the base material films F1 and F2 on each other upon changing from continuous feeding to intermittent feeding to obtain the film F, and performs processes such as sealing and cutting. A reference length L (see FIG. 2A) of one bag to be manufactured is initially set as a feed amount in the bag making machine 1 by inputting the length from a control panel (not shown) of the bag making machine 1. The reference length L is the length of a bag which is planned at first.

The original film G is fed out from the original roll by the feed shaft 21 with the widthwise direction of the film extending along the horizontal direction. The direction of the original film G is then changed by the turn bar 22 such that the widthwise direction of the film extends along the vertical direction. The slit blade 23 then cuts the original film G along the middle in the widthwise direction into the two base material films F1 and F2. The directions of the base material films F1 and F2 are changed by the turn bars 24, 24 such that the width direction of each film extends along the horizontal direction and the two films face each other. The base material films F1 and F2 are then changed by the plurality of dancer rollers 25 from continuous feeding to intermittent feeding. Subsequently, the base material films F1 and F2 are passed between the pair of upper and lower adjusting rollers 28, 28 to be brought close to each other and overlaid on each other by the feed rollers 26, 26 with a pressure to form the film F and also intermittently transferred toward the transverse sealing device 4. The bag making machine 1 is configured to perform processes such as sealing and cutting with respect to the film F for each length of one bag, and hence the length by which the film F is intermittently transferred at one time (i.e., the feed amount) is set to the length of one bag. The feed amount is set to the initially set reference length L at an early stage of a bag making process. However, when, for example, the film F has expanded due to the tension, etc., exerted by the dancer rollers 25 or the feed rollers 26, the actual length of one bag becomes longer than the reference length L. This may cause insufficiency in the initially set feed amount.

When the film F intermittently stops, the lifting members lower the upper seal bar 41 and the upper cooling bar 51, which then respectively perform heat sealing and cooling with respect to the film F.

The heat-sealed and cooled film F passes below the line sensor 71. The line sensor 71 continuously shoots the passing film F at high speed and sequentially outputs acquired linear images to the image processing device 91.

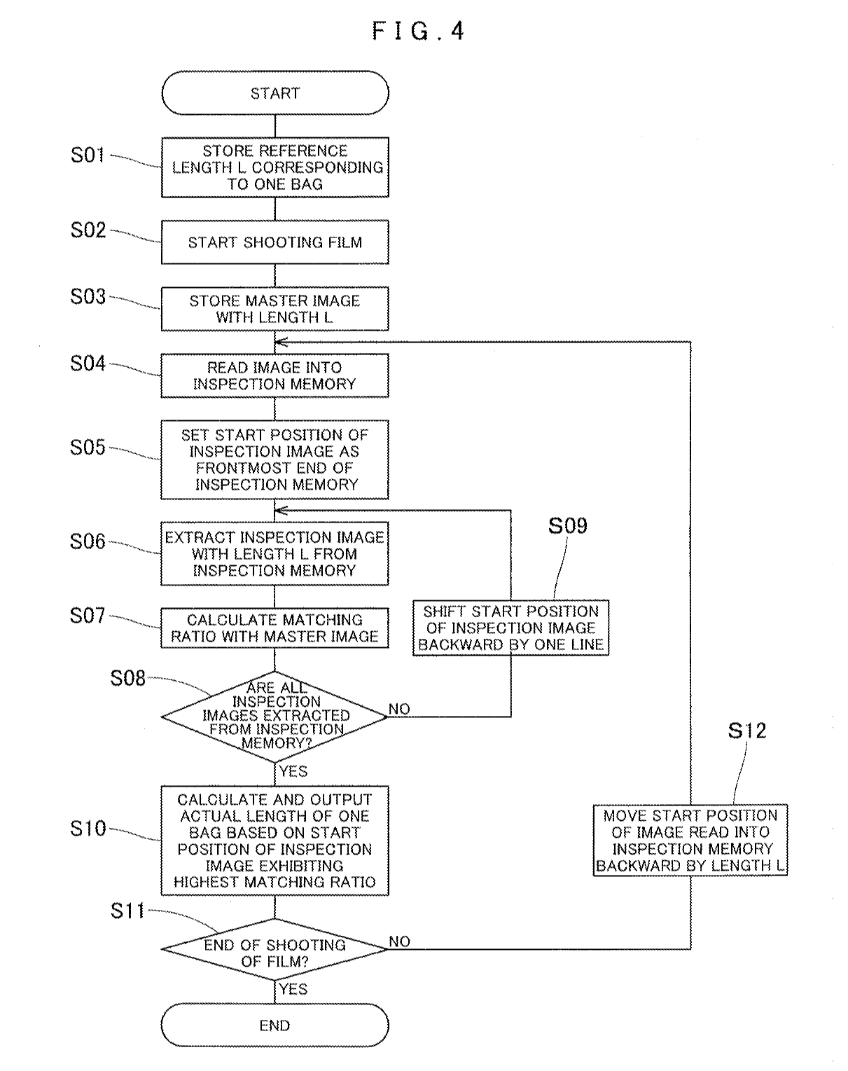

The film F that has passed below the line sensor 71 reaches below the cutter 8. When the film F intermittently stops, the lifting member lowers the upper cutting blade 81 of the cutter 8 to cut the film, thereby manufacturing separate bags. Image processing performed by the image processing device 91 will be described. The operator inputs the reference length L to the image processing device 91 by using the input unit (e.g., the keyboard) of the image processing device 91 before the start of a bag making process (see step S01 in FIG. 4). Note that the reference length L may be input to the image processing device 91 from the control panel of the bag making machine 1 described above.

As indicated by FIG. 2A, assume that the print pattern “A” has been repeatedly printed on the upper surface of the film F at a print pitch corresponding to one bag. Note that a portion other than the print pattern “A” may be either colorless or colored. In this embodiment, for the sake of simplicity, assume that a print pattern is formed only on the upper surface of the film F. However, as described later, a print pattern may also be formed on the lower surface of the film F. The operator sets the film F at the start of a bag making process such that a boundary portion K indicated by the alternate long and two short dashed lines in FIGS. 2A and 3A is placed in the shooting area of the shooting device 6. Accordingly, the shooting device 6 starts shooting from the boundary portion K between bags (see step S02 in FIG. 4). This shooting start position is denoted by reference character S in FIGS. 2A and 3A. Note that the boundary portion K is based on the initially set reference length L corresponding to one bag, and the actual boundary portion between bags is sometimes displaced from the boundary portion K because expansion and contraction occur in the film F in a bag making process, as described above.

The shooting device 6 continuously shoots the film F sent by the feeding mechanism 2 at a predetermined shooting period, and then sequentially transmits linear images to the image processing device 91. A shooting period is determined on the basis of the feed amount of the film F and the width of the shooting area of the shooting device 6 which extends along the lengthwise direction of the film F so as to obtain a full-surface image having as few gaps as possible when the linear images obtained from the shooting device 6 are arranged in shooting order.

The image processing device 91 sequentially receives linear images from the shooting device 6, forms a master image M as an image extending throughout the width of the film F and an inspection image E as an image extending throughout the width of the film F from a plurality of continuous linear images, and detects the actual length of one bag of the film F on the basis of the master image M and the inspection image E. The master image M and the inspection image E are full-surface images.

More specifically, as indicated by FIG. 2A, upon receiving linear images corresponding to the length L from a shooting start position S, the image processing device 91 stores, in the memory 93, an image formed by arranging the linear images in shooting order as the master image M (see step S03 in FIG. 4). The master image M is the image extending throughout the width of the film F, starting from the shooting start position S as a predetermined start position and having the reference length L corresponding to one bag.

Next, the image processing device 91 repeatedly forms an inspection image E having the length L and extending throughout the width of the film F from a plurality of continuous linear images and calculates the matching ratio between the inspection image E and the master image M stored in the memory 93 while shifting the start position of the inspection image E to be formed backward along the lengthwise direction of the film F. The image processing device 91 then detects the actual length of one bag on the basis of the start position of the inspection image E determined as an image matching the master image M on the basis of the matching ratio.

The following is an example of a method for detecting the actual length of one bag. The image processing device 91 reads, into the inspection memory 94, an image of a range larger by a length L₁ at each of the forward and backward positions than the initially set range of one bag, i.e., the range of the length L starting from the boundary portion K (excluding the boundary portion K at the shooting start position S) to the next boundary portion K (see FIG. 2A and step S04 in FIG. 4). The length of the inspection memory 94 is set to L+2L₁. The length L₁ is the length determined in advance in consideration of the expansion amount of the film F, and, more specifically, is the length determined in advance such that the length of one bag which is expected when the film F expands most is shorter than L+2L₁. The image read into the inspection memory 94 is a full-surface image. In the following description, a linear image is sometimes abbreviated as a line. Assume that the forward and backward positions of an image indicate those in the feeding direction D of the film F.

First, the image processing device 91 extracts an inspection image E having the length L from the inspection memory 94 (see step S06 in FIG. 4) upon setting the start position (i.e., the leading edge position) of the inspection image E to be extracted as the front end line of the inspection memory 94 (see step S05 in FIG. 4). The image processing device 91 then calculates a matching ratio with the master image M by using a normalized correlation function (e.g., Normalized Cross-Correlation) (see step S07 in FIG. 4). The normalized correlation function is well known, and hence a description of the function will be omitted. Next, the image processing device 91 then determines whether all the inspection images E are extracted from the images read into the inspection memory 94 at that point of time (see step S08 in FIG. 4). If NO in this step, the image processing device 91 shifts the start position of an inspection image E to be extracted backward by one line (see step S09 in FIG. 4), and extracts the inspection image E (see step S06 in FIG. 4). Upon determining that all the inspection images E are extracted from the images read into the inspection memory 94 at that point of time, the image processing device 91 determines that the inspection image E exhibiting the highest matching ratio is an image matching the master image M, and calculates the actual length of one bag on the basis of the start position of the inspection image E (see step S10 in FIG. 4). More specifically, as indicated by FIG. 2B, the image processing device 91 calculates a distance L₂ from the front end line of the image read into the inspection memory 94 to the front end line of the inspection image E exhibiting the highest matching ratio, and calculates the length of one bag according to L+L₂−L₁ where L₂ is the distance and L₁ is the length. That is, the image processing device 91 determines that the length of one bag has not changed from the initially set length L if L₂=L₁, the length of one bag has expanded by L₂−L₁ if L₂>L₁, or the length of one bag has contracted by L₁−L₂ if L₂<L₁. In other words, the image processing device 91 calculates an expansion/contraction length from the reference length L on the basis of displacement between the start position of the inspection image E determined as an image matching the master image M and the boundary portion K based on the reference length L, and then calculates the actual length of one bag.

The image processing device 91 outputs the actual length of one bag and a change in the actual length of one bag to the monitor 92. The monitor 92 then displays these pieces of information (see step S10 in FIG. 4). The change in the actual length of one bag is the expansion/contraction length from the reference length L. Note that when the actual length of one bag has changed, an inspection image E having the length after the change may be newly set as a master image M. That is, the master image M and the reference length L may be updated. In addition, when the expansion/contraction length has exceeded a predetermined range, a warning may be output from the monitor 92.

Next, the image processing device 91 determines whether shooting of the film F is complete (see step S11 in FIG. 4). If NO in this step, the image processing device 91 moves the start position of an image to be read into the inspection memory 94 backward by the length L (see step S12 in FIG. 4), and reads the new image into the inspection memory 94 (see step S04 in FIG. 4). On the other hand, upon determining that shooting of the film F is complete, the image processing device 91 terminates the image processing. The shooting device 6 stops shooting on the basis of the bag making stop condition input by the operator using the control panel of the bag making machine 1, and transmits a shooting stop signal to the image processing device 91. The image processing device 91 determines whether shooting of the film F is complete, depending on whether the shooting stop signal is received.

FIG. 2A shows a case in which after a master image M is read, an image is read into the inspection memory 94 at first. FIG. 3A shows a case in which an image is read into the inspection memory 94 after the case shown in FIG. 2A. FIG. 3A indicates a case in which an image having the length L from the shooting start position S is stored as a master image M, an image of a range larger by the length L₁ at each of the forward and backward positions than the range of the length L starting from the boundary portion K to the next boundary portion K is read into the inspection memory 94. FIGS. 3B, 3C, and 3D indicate a case in which inspection images E each having the length L are sequentially extracted while the start position is shifted backward from the leading edge of the image read into the inspection memory 94. In this manner, the image processing device 91 sequentially extracts inspection images E from the images read into the inspection memory 94, and calculates the matching ratio between each inspection image E and the master image M. The image processing device 91 then determines an inspection image E exhibiting the highest matching ratio as an image matching the master image M, and calculates the change in the actual length of one bag and the actual length of one bag on the basis of the start position of the inspection image E. The image processing device 91 reads the next image into the inspection memory 94, and calculates the change in the actual length of one bag and the actual length of one bag in the same manner as described above. The image processing device 91 then outputs the calculated information to the monitor 92. Accordingly, the actual length of one bag and the change in the actual length of one bag displayed on the monitor 92 is sequentially updated.

Note that the image processing device 91 may detect only one of the actual length of one bag and the change in the actual length of one bag. The image processing device 91 may output only one of the actual length of one bag and the change in the actual length of one bag to the monitor 92. The monitor 92 may display only one of the actual length of one bag and the change in the actual length of one bag.

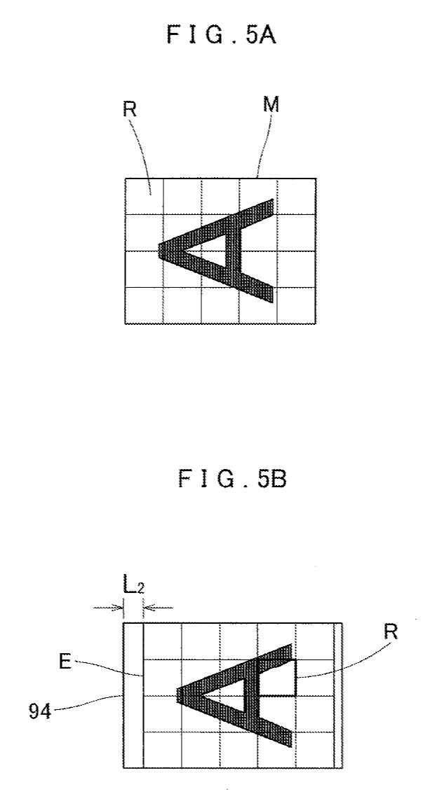

When the portion other than the print pattern “A” is colorless and transparent, the image processing device 91 may perform processing for removing the influence of the color of an object located on the reverse surface side of the film F. Such processing includes, for example, the processing of placing a background member such as a sheet having a predetermined background color on the reverse surface side of the film F in the shooting area of the shooting device 6 and handling the portion with the background color as a colorless portion in image processing. Note that the image processing device 91 may handle the background color as part of the colors of a master image M and an inspection image E instead of handling it as colorless. This is because the shooting position of the shooting device 6 does not change between when a master image M is acquired and when an inspection image E is acquired, and hence the background color of the master image M remains the same as that of the inspection image E, and there is no influence on the calculation of a matching ratio. The image processing device 91 also detects the distortion or uneven thickness of the film F on the basis of a master image M and an inspection image E. Note that the distortion includes creases. An example of this detection method is to segment a master image M and an inspection image E determined as an image matching the master image M into a plurality of regions R and calculate the matching ratios between the respective corresponding regions R, as indicated by FIGS. 5A and 5B. The image processing device 91 determines that distortion or uneven thickness has occurred in the region R exhibiting a matching ratio lower than a predetermined level. With this operation, for example, the image processing device 91 determines whether distortion or uneven thickness has occurred in the region R surrounded by the thick frame, as indicated by FIG. 5B. Note that the image processing device 91 may further perform image processing to determine whether a detected defect is distortion or uneven thickness. Upon detecting distortion or uneven thickness, the image processing device 91 outputs a distortion or uneven thickness detection signal to the monitor 92. Based on this signal, the monitor 92 displays information indicating the detection of distortion or uneven thickness together with, for example, information that can specify the place of occurrence.

The image processing device 91 further detects displacements in the widthwise direction between the master image M and the inspection image E determined as an image matching the master image M. Upon continuously detecting a displacement exceeding a predetermined range a plurality of times, the image processing device 91 outputs a meandering detection signal to the monitor 92 to indicate that the film F is meandering.

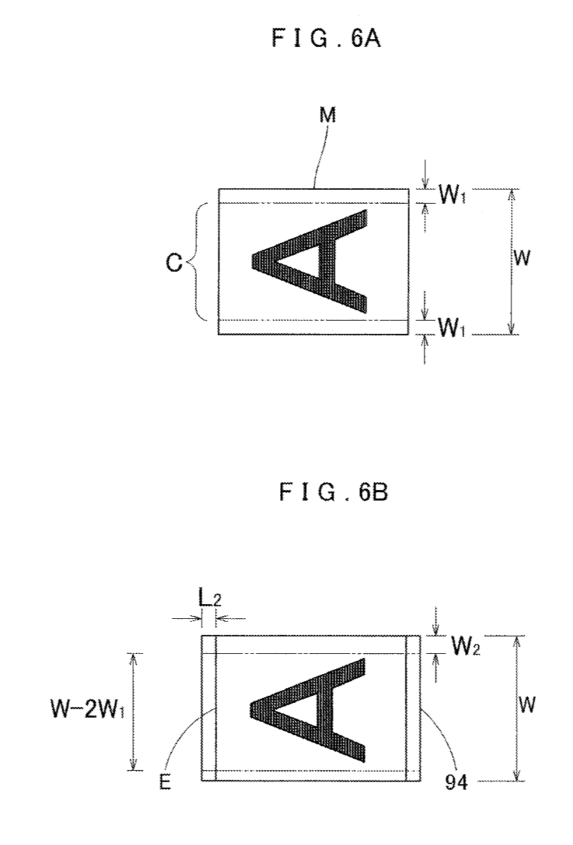

An example of a meandering detection method is to set, as a comparison range C, the range obtained by removing a predetermined width W₁ from each of both the ends of the master image M in the widthwise direction, as indicated by FIG. 6A, and detect a range, of an inspection image E determined as an image matching the master image M, which most matches the comparison range C, i.e., which exhibits the highest matching ratio. For example, the image processing device 91 may sequentially extract an image with a width W−2W₁ while shifting the start position of the image along the widthwise direction of the inspection image E from one end of the inspection image E in the widthwise direction, and calculate the matching ratio between each extracted image and the comparison range C. Note that W represents the width of a master image M and an inspection image E. As indicated by 6B, assume that the range of the inspection image E which exhibits the highest matching ratio with respect to the comparison range C is separated from one end of the inspection image E in the widthwise direction by a distance W₂. In this case, based on the distances W₂ and W₁, the image processing device 91 detects no displacement in the widthwise direction if W₂=W₁, detects a displacement on one end side in the widthwise direction if W₂<W₁, and detects a displacement on the other side in the widthwise direction if W₂>W₁. The image processing device 91 sequentially detects such a displacement in the widthwise direction with respect to each inspection image E determined as an image matching the master image M. Upon continuously detecting a displacement exceeding a predetermined range a predetermined number of times, the image processing device 91 determines that the film F is meandering. Upon detecting meandering, the image processing device 91 outputs a meandering detection signal to the monitor 92. Based on the signal, the monitor 92 displays information indicating the detection of meandering.

Based on the information displayed on the monitor 92, the operator adjusts the position to seal, the position to cool, the tension of the film F, the feed amount of the film F, etc., as needed. This makes it possible to restrict the occurrence of defective products by adjusting the sealing position, the cooling position, and the cutting position of the film F or correcting the distortion, uneven thickness, and meandering of the film F. Note that “sealing position” indicates a position on the film F, and “position to seal” indicates a position in the bag making machine 1. The same applies to the cooling position and the position to cool and to the cutting position and the position to cut. The bag making machine 1 adjusts the position to seal by moving the position of the transverse sealing device 4. This adjustment may be performed by adjusting only the position of the upper seal bar 41 and the lower seal bar 42 instead of adjusting the overall transverse sealing device 4. The same applies to the position to cool and the position to cut. Note that in this embodiment, the position to cut, i.e., the position of the cutter 8, is not moved. This is because the cutting position of the film F can be adjusted without moving the cutter 8, as will be described later.

When, for example, the length of a bag increases or decreases, the handle 44 is operated to move the transverse sealing device 4 so as to adjust its position to a position corresponding to the length of the bag. More specifically, the handle 44 is operated to move the transverse sealing device 4 so as to adjust its position to a position separated from the position of the cutter 8 by an integer multiple (triple in this embodiment) of the actual length of one bag. In addition, the motor 29 and the motor 30 are numerically controlled to adjust the feed amount of the film F in accordance with the actual length of one bag. This will adjust the sealing position of the film F (i.e., the sealing pitch of the film F) and the cutting position of the film F (i.e., the cutting pitch of the film F). The cooling device 5 is moved, as needed, by operating the handle 54. When distortion, uneven thickness, or meandering is detected, the tension of the film F is adjusted by adjusting the air pressure of the dancer rollers 25 and the pressure of the feed rollers 26, 26 and the feed rollers 27, 27, and the feed amount of the film F is adjusted by numerically controlling the motors 29 and 30. Note that adjusting the tension of the film F includes adjusting the tension of only one of the base material films F1 and F2.

According to the bag making machine 1 described above, since a change in the length (i.e., the pitch) of a predetermined number of bags (one bag in this embodiment) is known, it is possible to restrict the occurrence of defective products by adjusting the position to seal, etc., a feed amount, etc. In addition, since a full-surface image of the film F is acquired with the line sensor 71, there is no need to install a camera, etc., facing a specific portion of the film F. This makes it possible to perform shooting at the same position even with a change in the print pattern on the film F. This facilitates settings before a bag making processing.

The bag making machine 1 also acquires a master image M while shooting the film F, and hence there is no need to prepare a master image M in advance. In this regard as well, it is easy to make settings before a bag making process. In addition, since there is no need to print a mark on a bag to detect a pitch, the degree of freedom in design of bags is enhanced.

The bag making machine 1 also detects the distortion, uneven thickness, and meandering of the film F on the basis of read images. This makes it possible to further restrict the occurrence of defective products by adjusting the tension and feed amount of a film in accordance with detection results. By acquiring a full-surface image of the film F in this manner, the bag making machine 1 can detect the meandering of the film F, and also can detect distortion (including creases) and uneven thickness of the film F regardless of the portions in which they occur.

### 2. Second Embodiment

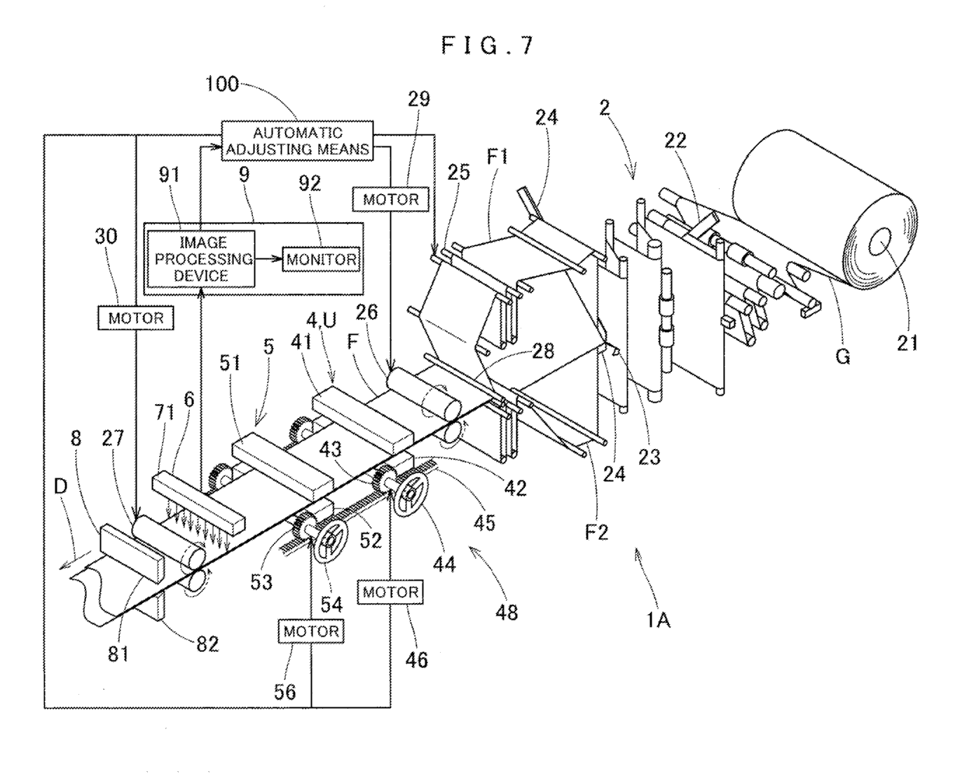

A bag making machine 1A according to the second embodiment shown in FIG. 7 includes, in addition to the components of the bag making machine 1, an automatic adjusting means 100 for automatically adjusting the position to perform processing (sealing, cooling, or cutting in this case) with respect to a film F, the tension of the film F, and the feed amount of the film F on the basis of detection results obtained by an image processing device 91, and also includes a motor 46 that causes a pinion 43 to pivot and a motor 56 that causes a pinion 53 to pivot. Note that the same reference characters denote the same members throughout the bag making machine 1 according to the first embodiment and the bag making machine 1A according to the second embodiment, and a description of the members will be omitted unless otherwise specified.

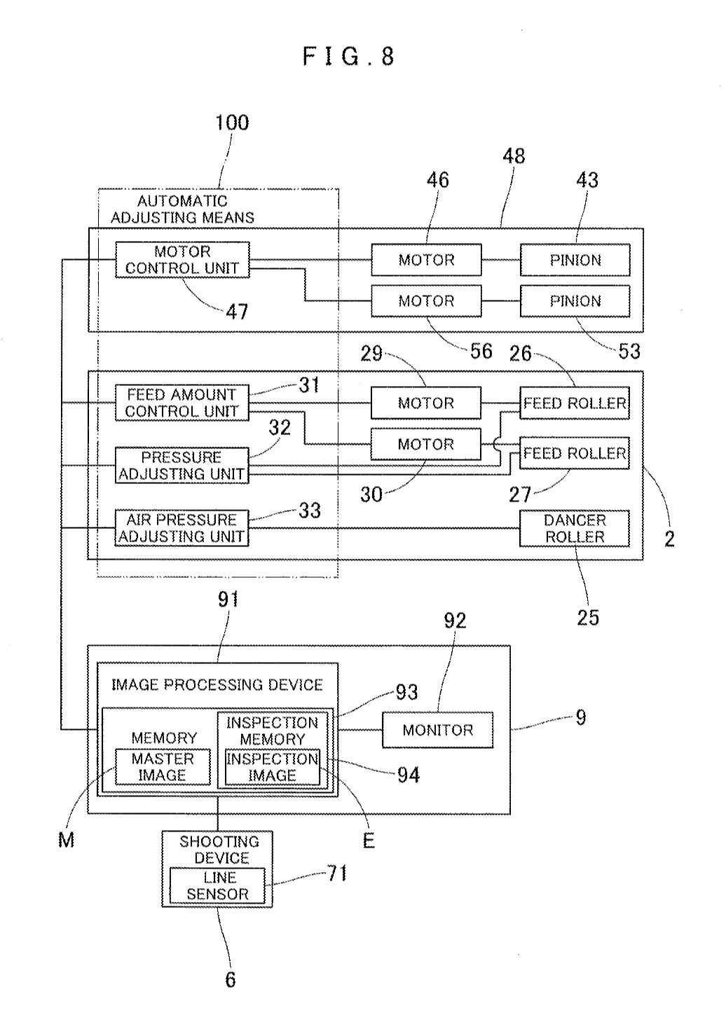

As shown in FIG. 8, the automatic adjusting means 100 includes a motor control unit 47, a feed amount control unit 31, a pressure adjusting unit 32, and an air pressure adjusting unit 33. The motor control unit 47, the feed amount control unit 31, the pressure adjusting unit 32, and the air pressure adjusting unit 33 are connected to the image processing device 91. The motor control unit 47, the motor 46 and the motor 56 constitute, together with, the pinion 43, the pinion 53 and a rack 45 (not shown in FIG. 8), a moving mechanism 48. The feed amount control unit 31, the pressure adjusting unit 32, and the air pressure adjusting unit 33 constitute, together with a motor 29, a motor 30, feed rollers 26, 26, feed rollers 27, 27, and a dancer roller 25, a feeding mechanism 2.

Automatic adjustment of the positions of a transverse sealing device 4 and a cooling device 5 will be described. The motor 46 and the motor 56 are connected to the motor control unit 47. The pivot shaft of the pinion 43 is coupled to the motor 46. The pivot shaft of the pinion 53 is coupled to the motor 56. The motor 46 serves to move the transverse sealing device 4. The motor 56 serves to move the cooling device 5. The image processing device 91 outputs the actual length of one bag and/or the change in the actual length of one bag to the motor control unit 47 in the moving mechanism 48. Based on the actual length of one bag and/or the change in the actual length of one bag, the motor control unit 47 outputs a control signal for moving the transverse sealing device 4 to the motor 46 and a control signal for moving the cooling device 5 to the motor 56 so as to perform heat sealing and cooling with respect to the film F for each actual length. The motors 46 and 56 respectively move the transverse sealing device 4 and the cooling device 5 by causing the pinions 43 and 53 to pivot in accordance with the respective control signals. This can reduce the time of manually adjusting the positions of the transverse sealing device 4 and the cooling device 5, thereby improving the work efficiency.

Note that in order to adjust the sealing position and cooling position of the film F, the feed amount of the film F is manually or automatically adjusted, together with the adjustment of the positions of the transverse sealing device 4 and the cooling device 5.

An example of automatic adjustment of the position to cut, i.e., the position of a cutter 8, is to move the cutter 8 by making the image processing device 91 output the actual length of one bag and/or the change in the actual length of one bag to a moving mechanism that is provided to move the cutter 8. An example of the moving mechanism for the cutter 8 is to provide a rack and a pinion similar to those of the transverse sealing device 4, a motor for causing the pinion to pivot, and a motor control unit for controlling the motor. In this case as well, the feed amount of the film F is manually or automatically adjusted. Note, however, that automatically adjusting the feed amount of the film F makes it possible to automatically adjust the cutting position of the film F without changing the position of the cutter 8.

Automatic adjustment of the feed amount of the film F will be described. The motor 29 and the motor 30 are connected to the feed amount control unit 31. The image processing device 91 outputs the actual length of one bag and/or the change in the actual length of one bag to the feed amount control unit 31 in the feeding mechanism 2. Based on the actual length of one bag and/or the change in the actual length of one bag, the feed amount control unit 31 outputs, to the motors 29 and 30, control signals each for adjusting at least the number of revolutions per unit time or the rotation angle. More specifically, the feed amount control unit 31 calculates at least the number of revolutions per unit time or the rotation angle as a target value for each of the motors 29 and 30 so as to set the feed amount of the film F in accordance with the actual length of one bag, and outputs control signals for achieving the target values to the motors 29 and 30. Accordingly, the feed amount based on the feed rollers 26, 26 and the feed rollers 27, 27 matches the actual length of one bag. This can reduce the time of manually adjusting the feed amount of the film F, thereby improving the work efficiency.

Although the feed amount based on the feed rollers 26, 26 is equal to that based on the feed rollers 27, 27 in this case, providing dancer rollers, etc., between the feed rollers 26, 26 and the feed rollers 27, 27 can make the feed amount based on the feed rollers 26, 26 different from that based on the feed rollers 27, 27.

Automatic adjustment of the tension of the film F will be described. The dancer roller 25 is connected to the air pressure adjusting unit 33. The air pressure adjusting unit 33 serves to adjust an air pressure to be applied to the dancer roller 25. The image processing device 91 outputs a meandering detection signal to the air pressure adjusting unit 33 in the feeding mechanism 2. Based on the input detection signal, the air pressure adjusting unit 33 adjusts an air pressure to be applied to the dancer roller 25. This adjusts the tension of each of base material films F1 and F2, i.e., the film F, and hence it is possible to reduce the time of manual adjustment, thereby improving the work efficiency.

The feed rollers 26, 26 and the feed rollers 27, 27 are also connected to the pressure adjusting unit 32. The pressure adjusting unit 32 serves to adjust the pressures applied by the feed rollers 26, 26 and the feed rollers 27, 27 to the film F. The image processing device 91 outputs a distortion or uneven thickness detection signal to the pressure adjusting unit 32 in the feeding mechanism 2. Based on the input detection signal, the pressure adjusting unit 32 adjusts the pressures to be applied by the feed rollers 26, 26 and the feed rollers 27, 27 to the film F. This will adjust the tension of the film F, thereby reducing the time of manual adjustment and improving the work efficiency.

As described above, the bag making machine 1A can reduce the time of manual adjustment and hence has the effect of improving the work efficiency as well as the same effects as those of the bag making machine 1.

### 3. Third Embodiment

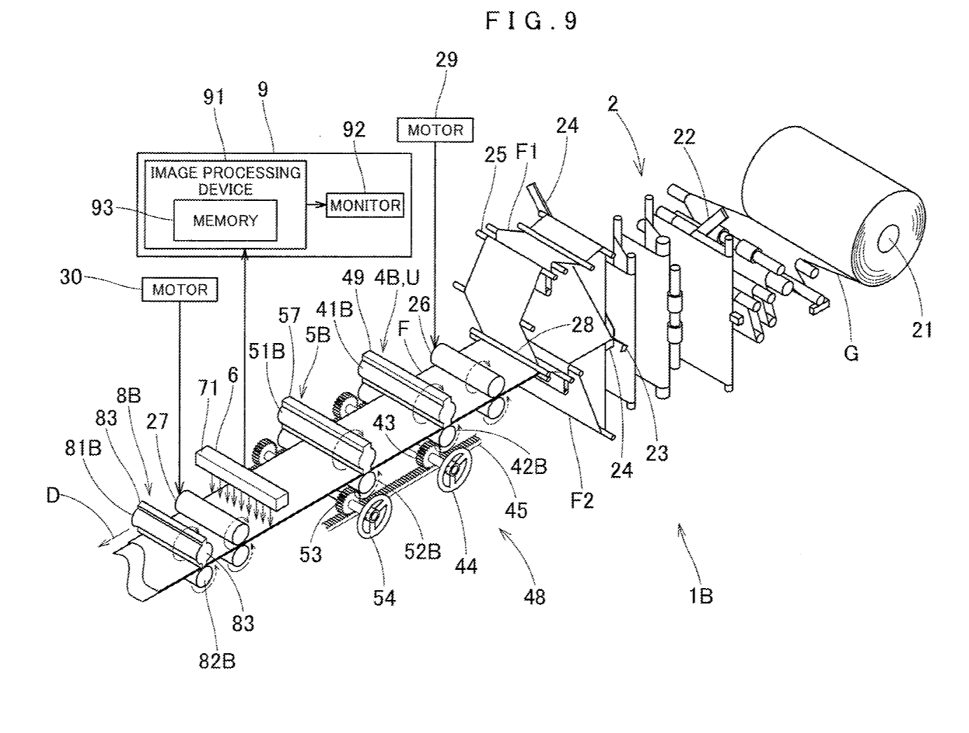

A bag making machine 1B according to the third embodiment shown in FIG. 9 is configured to perform processes such as sealing and cutting while performing continuous feeding instead of intermittent feeding. The feed amount in the case of continuous feeding corresponds to the length of a bag as a product (i.e., a product length). Note that the same reference characters denote the same members throughout the bag making machine 1 according to the first embodiment and the bag making machine 1B according to the third embodiment, and a description of the members will be omitted unless otherwise specified.

In the bag making machine 1B, a dancer roller 25 does not serve to change continuous feeding to intermittent feeding but serves to apply tension to each of base material films F1 and F2, i.e., a film F. A transverse sealing device 4B includes an upper seal roller 41B and a lower seal roller 42B that are arranged with their pivot shafts extending along the widthwise direction of the film F. One or more (two in this case) seal bar portions 49 are formed on the outer circumference of the upper seal roller 41B so as to protrude in an elongated shape along the axial direction. Each seal bar portion 49 is configured to be heated by a heater. Note that the seal bar portions 49 may be formed on the lower seal roller 42B. A cooling device 5B includes an upper cooling roller 51B and a lower cooling roller 52B arranged with their pivot shafts extending along the widthwise direction of the film F. One or more (two in this case) cooling bar portions 57 are formed on the outer circumference of the upper cooling roller 51B so as to protrude in an elongated shape along the axial direction. Each cooling bar portion 57 has a cooling water path formed inside itself. Note that the cooling bar portions 57 may be formed on the lower cooling roller 52B. A cutter 8B includes an upper cutting blade 81B and a lower cutting blade 82B arranged with their pivot shafts extending along the widthwise direction of the film F. One or more (two in this case) cutting blade portions 83 are formed on the outer circumference of the upper cutting blade 81B so as to protrude in an elongated shape along the axial direction. Note that the cutting blade portions 83 may be formed on the lower cutting blade 82B.

In the bag making machine 1B, at the time of bag making, the feed rollers 26, 26, the upper and lower seal rollers 41B and 42B, the upper and lower cooling rollers 51B and 52B, feed rollers 27, 27, and the upper and lower cutting rollers 81B and 82B continuously rotate. Each seal bar portion 49 reciprocates between the highest raised position and the lowest lowered position as the upper seal roller 41B rotates. Each cooling bar portion 57 reciprocates between the highest raised position and the lowest lowered position as the upper cooling roller 51B rotates. Each cutting blade portion 83 reciprocates between the highest raised position and the lowest lowered position as the upper cutting blade 81B rotates.

The film F passes between the upper seal roller 41B and the lower seal roller 42B. In this process of passing, when any of the seal bar portions 49 is located at the lowest lowered position, the film F is held between the seal bar portion 49 and the lower seal roller 42B and subjected to heat sealing. Next, the film F passes between the upper cooling roller 51B and the lower cooling roller 52B. In this process of passing, when any of the cooling bar portions 57 is located at the lowest lowered position, the film F is held between the cooling bar portion 57 and the lower cooling roller 52B and is cooled. In addition, the film F passes between the upper cutting blade 81B and the lower cutting blade 82B. In this process of passing, when any of the cutting blade portions 83 is located at the lowest lowered position, the film F is held between the cutting blade portion 83 and the lower cutting blade 82B and cut.

As in the bag making machine 1, in the bag making machine 1B, the interval between the position to seal and the position to cool is set to the length of one bag, and the interval between the position to cool and the position to cut is set to the length of two bags. It is therefore necessary to acquire the actual length of one bag (i.e., a product length).

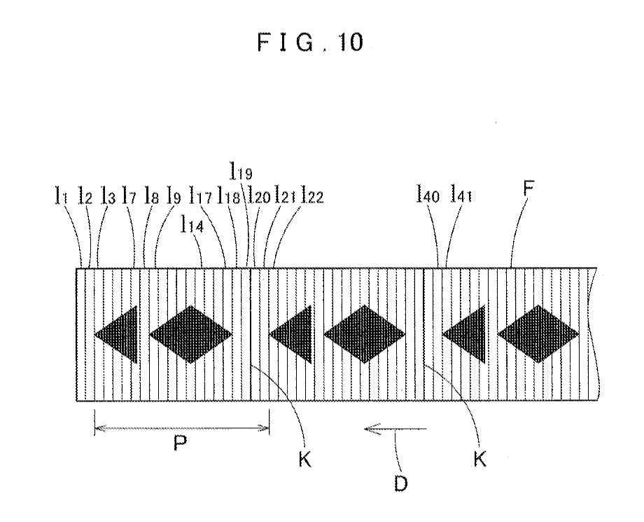

An example of image processing performed by an image processing device 91 of the bag making machine 1B to acquire a product length (i.e., a bag pitch) will be described with reference to FIG. 10. Assume that in the example shown in FIG. 10, the film F has triangular and rectangular print patterns having the same color as print patterns on one bag, and the first half part of each rectangular print pattern and each triangular print pattern have the same shape and are arranged at the same position in the widthwise direction of the film F. In the example shown in FIG. 10, the portion other than these print patterns is colorless (i.e., has no ground color). Obviously, however, this portion may be colored as will be described later. The film F is continuously fed in the direction indicated by an arrow D, and the image processing device 91 acquires a full-surface image of the surface of the film F on which print patterns are printed with the shooting device 6 formed from a line sensor 71. The solid lines along the widthwise direction of the film F shown in FIG. 10 conceptually represent the boundaries between linear images acquired by one shooting operation with the line sensor 71. The thick solid lines of these solid lines represent boundary portions K. In practice, each linear image obtained by the line sensor 71 has a very small width. However, for the sake of easy understanding, each linear image shown has a certain width. Note that “width” in this case is a length along the long direction of the film F. As described above, a linear image is called a “line,” and the forward and backward positions of an image are those in the feeding direction D of the film F.

The image processing device 91 sequentially reads the lines obtained by shooting with the line sensor 71 into a memory 93. The image processing device 91 then detects a first line I₃ having a color on the basis of the RGB value of the respective pixels in each line, and set the detected line as a reference line. The RGB value represents a color by a combination of red, green and blue values. Note that other values representing colors may be used instead of the RGB values. When, for example, the RGB value of any pixel in a given line exceeds a predetermined threshold, the image processing device 91 determines that the line has a color. Next, based on the RGB values of the respective pixels of lines, the image processing device 91 then detects a line that belongs to an image identical to the image to which the reference line I₃ belongs with a line of a different image existing between itself and the reference line I₃. Such a line will be referred to as a comparison start line hereinafter. For example, assume that RGB values are compared between corresponding pixels, and the RGB values are almost equal to each other (i.e., fall within a predetermined difference range) between all the pixels. In this case, the image processing device 91 determines that the corresponding images are identical to each other. The comparison start line requires that a line of a different image exists between itself and the reference line I₃ because the image processing device 91 cannot determine any repetition of a print pattern without a change in color. A change in color in this case includes not only a change from a given color to another color but also a change between colored and colorless, i.e., a change of a colored region. Referring to FIG. 10, a line I₉ is determined as a comparison start line.

Upon detecting the comparison start line I₉, the image processing device 91 compares the image constituted by six lines, namely, the reference line I₃ to line I₈ immediately before the comparison start line I₉, with the image constituted by six lines counted backward from the comparison start line I₉, i.e., the image constituted by the line I₉ to a line I₁₄. If these images are identical to each other, the image processing device 91 determines that a repetition of the same print pattern has appeared. On the other hand, if these images differ from each other, the image processing device 91 further searches backward for a comparison start line. In the example shown in FIG. 10, the image processing device 91 determines that the images differ from each other, further searches for a comparison start line, and detects a line I₂₂.

The image processing device 91 compares the image constituted by 19 lines, namely, the reference line I₃ to a line I₂₁ immediately before the comparison start line I₂₂, with the image constituted by 19 lines counted backward from the comparison start line I₂₂, i.e., the image constituted by the line I₂₂ to a line I₄₀. Since these images are identical to each other, the image processing device 91 determines that a repetition of a print pattern has appeared. The image processing device 91 compares the image constituted by 19 lines, namely, the reference line I₃ to the line I₂₁, with the image constituted by 19 lines counted backward from a line I₄₁ next to the line I₄₀, and confirms that the same print pattern is repeated. When the same print pattern appears a predetermined number of times, the image processing device 91 determines that the print pattern is repeated, and determines that a pitch P of the repeated print pattern corresponds to a bag pitch (i.e., a product length). The image processing device 91 detects a change in bag pitch by monitoring the pitch P of the repeated print pattern.

In the example shown in FIG. 10, if the portion other than the triangular and rectangular print patterns is colored (i.e., has a ground color), the image processing device 91 sets the first read line I₁ as a reference line. Although the image processing device 91 then determines the line I₂ next to the line I₁ as the reference line Iₜ since there is no line of a different image between the line I₂ and the line I₁, the image processing device 91 does not determine that the line I₂ is a comparison start line, but determines the line I₈ as a comparison start line. The image processing device 91 then compares the image constituted by the reference line I₁ to the line I₇ immediately before the comparison start line I₈ with the image constituted by the same number of lines (eight lines in this case) from the comparison start line I₈. In the example shown in FIG. 10, since these images differ from each other, the image processing device 91 detects the next comparison start line I₁₈. In this manner, when the line I₂₀ is set as a comparison start line, the image processing device 91 finally determines that the image constituted by the reference line I₁ to the line I₁₉ immediately before the comparison start line I₂₀ is repeated from the comparison start line I₂₀, and sets the pitch of the repeated images as a product length.

In this manner, the bag making machine 1B detects the repetitions of print patterns on the image formed throughout the width of the film F, and sets the repetition pitch P as a product length (i.e., the actual length of one bag). Note that in order to restrict measurement errors, a reference pitch as a bag pitch may be calculated from, for example, the average of a plurality of pitches P obtained by detecting the pitch P of the print patterns a plurality of times while feeding the film F.

In the bag making machine 1B, the line sensor 71 can detect a product length by acquiring a full-surface image of the surface of the film F which has a print pattern without inputting a feed amount (i.e., a product length) in advance. It is possible to restrict the occurrence of defective products by manually or automatically adjusting the position to process the film F, the feed amount of the film F, etc., on the basis of the detected product length. In addition, only allowing the shooting device 6 to shoot the film F having a length that allows a print pattern to be repeated a few times at the start of an operation makes it possible to detect a product length and eliminate the necessity to change the position of the shooting device 6 even when the print pattern on the film F changes. This can facilitate settings before a bag making process.

Note that in a bag making machine based on an intermittent feed scheme like the bag making machine 1, it is possible to initially set no feed amount before the start of an operation. This is because a product length is detected on the basis of the pitch P of the repetition of a print pattern as in the bag making machine 1B, and the product length is set as a feed amount.

### 4. Fourth Embodiment

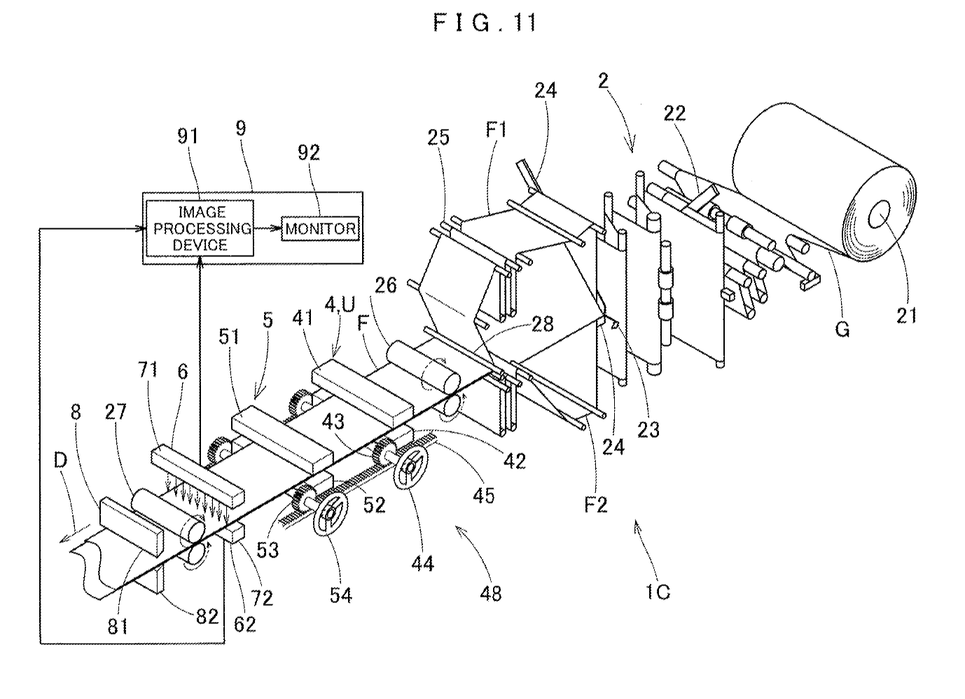

In a bag making machine 1C according to the fourth embodiment shown in FIG. 11, a film F has print patterns repeatedly printed on the two surfaces of a film F at a print pitch corresponding to one bag, and an image processing device 91 is configured to acquire full-surface images of the two surfaces of the film F by using a shooting device 6 as the first shooting device and a shooting device 62 as the second shooting device. The image processing device 91 detects displacement between base material films F1 and F2 forming the two surfaces of the film F on the basis of the acquired images. Note that displacement between the base material films F1 and F2 is the relative displacement between the base material films F1 and F2, i.e., the displacement from the proper overlaying state between the base material films F1 and F2. Note that the same reference characters denote the same members throughout the bag making machine 1 according to the first embodiment and the bag making machine 1C according to the fourth embodiment, and a description of the members will be omitted unless otherwise specified.

This machine will be described in detail below. Print patterns are repeatedly printed on one surface as the front surface of the film F and the other surface as the reverse surface of the film F at a print pitch corresponding to the length of one bag. Note that the front surface corresponds to the upper surface of the base material film F1, and the reverse surface corresponds to the lower surface of the base material film F2. Print patterns on the front and reverse surfaces may either be identical or different. As shown in FIG. 11, the shooting device 62 includes a line sensor 71 and a line sensor 72 similar to the line sensor 71. The line sensor 72 is placed downstream of a cooling device 5 in a feeding direction D of the film F with the longitudinal direction of the line sensor 72 extending along the widthwise direction of the film F. In addition, the line sensor 72 is placed on the reverse surface side (i.e., the lower surface side) of the film F and performs shooting from a direction perpendicular to the film F. The shooting device 62 is connected to the image processing device 91, and sequentially outputs the linear images obtained by shooting with the line sensor 72 to the image processing device 91. Referring to FIG. 11, the line sensor 72 is placed to face the line sensor 71. However, the line sensor 72 may be displaced to the downstream side or the upstream side from the position facing the line sensor 71.

The image processing device 91 detects a print pattern pitch on the front surface (i.e., the actual length of one bag on the front surface) and a print pattern pitch on the reverse surface (i.e., the actual length of one bag on the reverse surface) on the basis of the full-surface image of the front surface of the film F constituted by linear images received from the shooting device 6 and the full-surface image of the reverse surface of the film F constituted by linear images received from the shooting device 62. As an example of this detection method, a method similar to that according to the first embodiment is available. If the difference (i.e., the displacement) between the print pattern pitch on the front surface and the print pattern pitch on the reverse surface falls within a predetermined range, the image processing device 91 determines that there is no displacement between the base material films F1 and F2 forming the two surfaces of the film F. If the above difference falls outside the predetermined range, the image processing device 91 determines that there is displacement between the base material films F1 and F2.

The displacements between print patterns of master images M and print patterns of inspection images E on the front surface and the reverse surface can also be grasped by, for example, storing in advance the master images M on the front surface and the reverse surface, each having a reference length L corresponding to one bag, simultaneously shooting the front surface and the reverse surface of the film F at the same region with the line sensors 71 and 72, capturing the inspection images E on the front surface and the reverse surface, each having the reference length L corresponding to one bag, and comparing the master images M with the inspection images E on the respective surfaces. If the degrees of displacements on the front surface and the reverse surface nearly match each other (i.e., fall within a predetermined range), the image processing device 91 may determine that there is no displacement between the base material films F1 and F2. If the degrees of displacements do not nearly match each other (i.e., fall outside the predetermined range), the image processing device 91 may determine that there is displacement between the base material films F1 and F2. This processing makes it possible to detect a case in which print pattern pitches on the front surface and the reverse surface are equal to each other, but the base material films F1 and F2 are displaced from each other as a whole.

Note that displacement between the base material films F1 and F2 includes not only displacement in the longitudinal direction of the base material films F1 and F2 but also displacement in the widthwise direction. Methods for detecting a displacement in the widthwise direction include, for example, a method including preparing master images M on the front surface and the reverse surface, comparing the master image M on the front surface with an inspection image E on the front surface, and comparing the master image M on the reverse surface with an inspection image E on the reverse surface, and a method including comparing a double-surface master image M obtained by concatenating master images M on the front surface and the reverse surface in the widthwise direction with an image obtained by concatenating inspection images E on the front surface and the reverse surface in the widthwise direction.

Upon detecting displacement between the base material films F1 and F2, the image processing device 91 outputs displacement detection signals concerning the base material films F1 and F2 to a monitor 92. The monitor 92 then displays information indicating displacement between the base material films F1 and F2.

Accordingly, the operator can restrict the occurrence of defective products by adjusting the tension, etc., of the film F. Note that, like the bag making machine 1A, the image processing device 91 may be configured to output displacement detection signals concerning the base material films F1 and F2 to a feeding mechanism 2 and a moving mechanism 48 so as to cause the feeding mechanism 2 and the moving mechanism 48 to automatically adjust the tension of the film F and the positions of the transverse sealing device 4, etc.

When the film F is a film having no optical transparency, e.g., a metal film, in particular, it is beneficial in terms of acquiring full-surface images of the two surfaces of the film F because the line sensors 71 and 72 are not affected by an object located on the opposite side of the film F to the surface to be shot. An example of such an object is a print pattern on a surface, of the film F, which is located on the opposite side to the surface to be shot. Obviously, however, even when the film F has optical transparency, full-surface images of the two surfaces of the film F may be acquired. This is because the influence of an object on the opposite side can be restricted by properly modulating an image processing method, illumination at the time of shooting, a background, the placement positions of the line sensors 71 and 72, the shooting timing, etc.

### 5. Modification and Application Examples

(1) Although the bag making machines 1, 1A, 1B, and 1C each are configured to sequentially perform three processes, namely, sealing, cooling, and cutting, the present invention can be applied to a bag making machine that is not configured to perform all three of these processes. For example, the present invention can also be applied to a bag making machine that does not include any cutter and is configured to wind a film having undergone sealing and cooling without cutting the film into separate bags, that is, a bag making machine that manufactures a continuum of bags. In addition, the present invention can be applied to a bag making machine that includes a cutter but does not include a sealing device and a cooling device, and is configured to only cut a sealed film (i.e., a continuum of bags). Furthermore, the present invention can be applied to a bag making machine including a longitudinal sealing device, a bag making machine including a punching (i.e., a hole piercing) device, and a bag making machine having no cooling device.

(2) In each embodiment described above, the film F is the one obtained by overlaying the two base material films F1 and F2 on each other. However, the film F may be the one obtained by folding one base material film, for example, the one obtained by folding a base material film into two. In such a case, the two surfaces of the film F are formed from a single base material film. That is, the two surfaces of the film F are formed from separate portions of the base material film. In addition, the film F may be formed by overlaying three or more base material films on each other, for example, folding a base material film forming a gusset and holding it between the base material films F1 and F2. Alternatively, the film F may be formed by overlaying base material films fed from a plurality of original rolls. In addition, the film F may have an arrangement other than the arrangement of films formed by overlaying a plurality of base material films on each other or folding one base material film.

(3) The film F that can be applied to the bag making machines 1, 1A, and 1B is not limited to a film having a print pattern only on one surface, and a film having print patterns on the two surfaces (for example, the upper surface of the base material film F1 and the lower surface of the base material film F2). When the film F has print patterns on the two surfaces and the portions other than the print patterns are transparent, the print pattern on the opposite side to the shot surface can be seen through. As a consequence, the print pattern on the opposite side is shot, together with the print pattern on the shot surface, with the shooting device 6. However, there is no need to distinguish the print pattern on the shot surface from the print pattern on the opposite side to the shot surface on the linear images acquired by the shooting device 6 and the full-surface image formed from the linear images. That is, these images may be handled as an integrated image. Note that it is also possible to perform processing upon removing the influence of the print pattern on the opposite side to the shot surface by properly modulating an image processing method, illumination at the time of shooting, a background, etc.

The present invention can also be applied to a bag making machine configured to process a film having print patterns repeatedly printed at a print pitch corresponding to a plurality of bags for each length corresponding to the plurality of bags. That is, any film having print patterns repeatedly printed at a print pitch corresponding to a predetermined number of bags on one or two surfaces can be applied to the bag making machine according to the present invention. In this case, the predetermined number of bags is not limited to one but may be two or more.

(4) A master image M acquisition method and an image processing method to be used are not limited to those described above. For example, the image processing device 91 may store in advance, in the memory 93, a master image M having the reference length L corresponding to one bag read from an external recording medium, and detect a bag pitch or the distortion, meandering, or uneven thickness of the film by comparison with the master image M. As a method of comparison with a master image M, for example, pattern matching disclosed in JP No.

2822830 B is available. In addition, monochrome images may be used instead of color images. That is, obviously a method for detecting a length corresponding to the predetermined number of bags of the film F, a method for detecting the distortion, meandering, and uneven thickness of the film F, and a method for detecting displacement between the two surfaces of the film F are not limited to those described above.

(5) The read start position of the line sensor 71 (i.e., the shooting start position S) need not always be set to the boundary portion K between bags, and a proper position can be selected for the following reason. For example, when a master image M is stored in the image processing device 91 in advance, the film F is shot with the line sensor 71 at an arbitrary position set as a read start position while the film F is fed by the feeding mechanism 2. When a plurality of images matching the master image M are detected, the pitch between the detected images is measured and set as a bag pitch. In addition, for example, it is possible to initially input the reference length L corresponding to a bag to the image processing device 91 instead of storing a master image M in advance. In this case, an image with the length L is read from an arbitrary read start position and set as a master image M. When a plurality of images matching the master image M are detected, the pitch between the detected images is measured and set as a bag pitch.

(6) In each embodiment described, the transverse sealing devices 4 and 4B each correspond to the processing unit U. However, the cooling devices 5 and 5B or the cutters 8 and 8B each may correspond to the processing unit U.

(7) The bag making machines 1 and 1A may be configured not to detect the distortion or uneven thickness of the film F or not to detect the meandering of the film F. The bag making machines 1B and 1C may be configured to detect the distortion or uneven thickness of the film F or detect the meandering of the film F.

(8) In each embodiment described above, the matching ratio between images is calculated by using the known normalized correlation function. However, other methods may be used.

What is claimed is:

1. A bag making machine for manufacturing bags or a continuum of bags from an elongated film having print patterns repeatedly printed on one surface or two surfaces at a print pitch corresponding to a predetermined number of bags, the machine comprising:
a feeding mechanism configured to feed the film in a lengthwise direction of the film;
a processing unit configured to process the film for each length corresponding to the predetermined number of bags;
a moving mechanism configured to move the processing unit;
a shooting device including not less than one line sensor installed with a longitudinal direction of the line sensor extending along a widthwise direction of the film, placed at a position allowing a surface of the film which has the print patterns to be shot on a feed route for the film fed by the feeding mechanism, and configured to obtain a linear image extending throughout a width of the film for each shooting operation, with a shooting range being a linear range extending throughout the width of the film; and
an image processing device configured to sequentially receive the linear images from the shooting device, detect an actual length of the predetermined number of bags of the film and/or a change in the actual length based on an image extending throughout the width of the film, which is formed from the plurality of continuous linear images, and output the actual length and/or the change in the actual length to at least one of the feeding mechanism, the moving mechanism, and a monitor.

2. The bag making machine according to claim 1, wherein the image processing device is configured to form a master image having a reference length corresponding to the predetermined number of bags, starting from a predetermined start position, and extending throughout a width of the film from a plurality of continuous linear images or read a master image having the reference length from an external recording medium, and store the master image in a memory,
repeatedly perform forming an inspection image having the reference length and extending throughout the width of the film from the plurality of continuous linear images and calculating a matching ratio between the inspection image and the master image stored in the memory while shifting a start position of the inspection image in a lengthwise direction of the film, and detect the actual length and/or the change in the actual length on the basis of the start position of the inspection image determined, based on the matching ratio, as an image matching the master image.

3. The bag making machine according to claim 1, wherein the image processing device is configured to detect a repetition of a print pattern on the image extending throughout the width of the film and set the repetition pitch as the actual length.

4. The bag making machine according to claim 1, wherein the image processing device is configured to output the actual length and/or the change in the actual length to the moving mechanism, and
the moving mechanism comprises
a motor configured to move the processing unit, and
a motor control unit configured to output, to the motor, a control signal for moving the processing unit so as to perform the processing with respect to the film for the each actual length based on the actual length and/or the change in the actual length input from the image processing device.

5. The bag making machine according to claim 1, wherein the image processing device is configured to output the actual length and/or the change in the actual length to the feeding mechanism, and
the feeding mechanism comprises
a feed roller configured to feed the film,
a motor configured to rotate the feed roller, and
a feed amount control unit configured to output, to the motor, a control signal for adjusting at least one of a number of revolutions per unit time and a rotation angle of the motor based on the actual length and/or the change in the actual length input from the image processing device.

6. The bag making machine according to claim 2, wherein the image processing device is configured to calculate a matching ratio between images of corresponding regions obtained when the master image and the inspection image determined as an image matching the master image are equally segmented into a plurality of regions, determine that distortion or uneven thickness of the film has occurred in the region exhibiting the matching ratio lower than a predetermined level, and output a distortion or uneven thickness detection signal to at least one of the feeding mechanism and the monitor.

7. The bag making machine according to claim 6, wherein the image processing device is configured to output the distortion or uneven thickness detection signal to the feeding mechanism, and
the feeding mechanism comprises
a feed roller configured to feed the film while applying a pressure on the film, and
a pressure adjusting unit configured to adjust the pressure that is applied to the film by the feed roller based on the distortion or uneven thickness detection signal input from the image processing device.

8. The bag making machine according to claim 2, wherein the image processing device is configured to detect a displacement in the widthwise direction between the master image and the inspection image determined as an image matching the master image and output, to at least one of the feeding mechanism and the monitor, a detection signal of the meandering of the film upon continuously detecting the displacement exceeding a predetermined range a predetermined plurality of times.

9. The bag making machine according to claim 8, wherein the image processing device is configured to set, as a comparison range, a range obtained by removing a predetermined width from each of two ends of the master image in a widthwise direction, detect a range, of the inspection image determined as an image matching the master image, which most matches the comparison range, and detect the displacement in the widthwise direction based on a position of the range most matching the comparison range in the inspection image.

10. The bag making machine according to claim 8, wherein the image processing device is configured to output the meandering detection signal to the feeding mechanism, and
the feeding mechanism comprises:
a dancer roller configured to apply tension to the film, and
an air pressure adjusting unit configured to adjust an air pressure applied to the dancer roller based on the meandering detection signal input from the image processing device.

11. The bag making machine according to claim 1, wherein the processing includes one of heat sealing, cooling, and cutting.

12. A bag making machine for manufacturing bags or a continuum of bags from an elongated film formed by overlaying a plurality of base material films on each other and having print patterns repeatedly printed on each of two surfaces of the film at a print pitch corresponding to a predetermined number of bags, the machine comprising:
a feeding mechanism configured to feed the film in a lengthwise direction of the film;
a processing unit configured to process the film for each length corresponding to the predetermined number of bags;
a moving mechanism configured to move the processing unit;
a first shooting device including not less than one line sensor installed with a longitudinal direction of the line sensor extending along a widthwise direction of the film, placed at a position allowing one surface of the film to be shot on a feed route for the film fed by the feeding mechanism, and configured to obtain a linear image extending throughout a width of the one surface of the film for each shooting operation, with a shooting range being a linear range extending throughout the width of the film;
a second shooting device including not less than one line sensor installed with a longitudinal direction of the line sensor extending along the widthwise direction of the film, placed at a position allowing the other surface of the film to be shot on the feed route for the film fed by the feeding mechanism, and configured to obtain a linear image extending throughout a width of the other surface of the film for each shooting operation, with a shooting range being a linear range extending throughout the width of the film; and
an image processing device configured to sequentially receive the linear images of the one surface from the first shooting device, detect an actual length of the predetermined number of bags on the one surface based on an image extending throughout the width of the one surface, which is formed from the plurality of continuous linear images of the one surface,
sequentially receive the linear images of the other surface from the second shooting device, detect an actual length of the predetermined number of bags on the other surface based on an image extending throughout the width of the other surface, which is formed from the plurality of continuous linear images of the other surface,
detect a displacement between the base material films forming two surfaces of the film based on the actual length of the predetermined number of bags on the one surface and the actual length of the predetermined number of bags on the other surface, and output a detection signal concerning the displacement between the base material films to at least one of the feeding mechanism, the moving mechanism, and a monitor.
